(19) United States
(12) Patent Application Publication
(10) Pub. No.: US 2026/0253176 A1
(43) Pub. Date: Aug. 27, 2026

(54) APPARATUS AND METHOD FOR PROCESSING IMAGES TO REMOVE NOISE IN SYNTHETIC IMAGES

(71) Applicant: HANWHA VISION CO., LTD., Seongnam-si (KR)

(72) Inventors: Euncheol CHOI, Seongnam-si (KR); Chang Min LEE, Seongnam-si (KR)

(73) Assignee: HANWHA VISION CO., LTD., Seongnam-si (KR)

(21) Appl. No.: 19/549,561

(22) Filed: Feb. 25, 2026

(30) Foreign Application Priority Data
Feb. 27, 2025 (KR) 10-2025-0026193

(51) Int. Cl. G06T 5/50; G06T 3/40; G06T 5/70

(52) U.S. Cl. CPC G06T 5/50; G06T 3/40; G06T 5/70; G06T 2207/10144; G06T 2207/20208; G06T 2207/20221

(57) ABSTRACT

A method for removing noise in synthetic images includes generating a synthetic image based on at least a first image received from a first-exposure channel and a second image received from a second-exposure channel using an image sensor, determining a fusion ratio for the first image and the second image based on the synthetic image, generating a synthetic weight image based on the fusion ratio, and performing noise removal on the synthetic image using the synthetic weight image.

### CROSS-REFERENCE TO RELATED APPLICATIONS

This application claims priority to Korean Patent Application No. 10-2025-0026193 filed on Feb. 27, 2025, in the Ministry of Intellectual Property (MOIP) of the Republic of Korea, the disclosure of which is incorporated herein in its entirety by reference.

### BACKGROUND

### 1. Field

This disclosure relates to an apparatus and method for processing images to remove noise in synthetic images.

### 2. Description of the Related Art

Recently, imaging technologies such as Wide Dynamic Range (WDR) or High Dynamic Range (HDR) have been adopted in the security camera field. These technologies may achieve a wide dynamic range beyond the image sensor's dynamic range by continuously shooting and synthesizing short-time exposed images (hereinafter referred to as “short-exposure images”) and long-time exposed images (hereinafter referred to as “long-exposure images”). In particular, the WDR technology shows a higher correction effect than the existing Back Light Compensation (BLC) technology, as a function that may implement clear images even in environments with large brightness differences.

Although WDR is a hardware-based processing technology and HDR is a software-based processing technology, both technologies have in common that they are particularly effective in scenes with very high contrast, such as backlighting compositions.

The images obtained by the image sensor contain noise due to the sensor's physical limitations, so noise removal in images captured with these WDR or HDR technologies is essential.

On the other hand, there is an increasing demand for non-face-to-face communication services, such as video conferencing and various Social Network Services (SNS), and research on image capturing functions, including WDR and HDR technologies, has been actively conducted in line with this trend.

The background technology of the present disclosure was written to facilitate understanding of the present disclosure. The subject matter described in the background technology should not be construed as admitted prior art.

### SUMMARY

In cases where the brightness of an image is dark or its details are unclear due to backlighting, various noise removal technologies are used to solve these problems.

Existing noise removal technologies remove noise using only an input image, regardless of HDR synthesis information. Common noise removal technologies include two (2)-Dimensional Noise Reduction (2DNR) and three (3)-Dimensional Noise Reduction (3DNR). Here, 2DNR is a technical method that performs two-dimensional noise reduction a the spatial domain, while 3DNR performs three-dimensional noise reduction by reducing noise in the spatial domain and then reducing noise in a temporal domain.

Among them, the 3DNR technology may include modules such as Motion Detection/Estimation (MD), Temporal Noise Reduction (TNR), and Spatial Noise Reduction (SNR). After performing MD by comparing a current input frame with a previous output image, TNR is applied to areas without motion using extracted motion information, and SNR (2DNR) is applied to areas with motion.

SNR is a method that uses surrounding pixel information of a pixel to be processed as a reference to remove noise in a current frame. This method has an advantage of avoiding blur or artifacts caused by motion because it uses only the current frame, without using previously processed images.

In contrast, TNR is a method of accumulating multiple frames. As the number of accumulated frames increases, noise decreases, and the level of an actual signal relatively rises, providing an advantage of obtaining exact information of a subject. As a result, TNR technology is essential in camera applications, such as surveillance cameras, where information is critical. However, to obtain a clean image with noise removed, a sufficient number of frames must be accumulated, which requires a corresponding accumulation time.

Thus, the inventor of this disclosure has invented a method and device that may efficiently remove noise by correcting an image obtained with an image sensor, regardless of whether the image is a long-exposure or a short-exposure.

Therefore, the present disclosure provides an apparatus and a method for processing images to remove noise in synthetic images that may more effectively remove noise by applying different settings based on a fusion ratio of long-exposure images or short-exposure images for each area in the synthetic image obtained by WDR technology or HDR technology. Synthetic images are also referred to as synthesized images.

Aspects of the present disclosure are not limited to those mentioned above, and other aspects not mentioned will be readily understood by those skilled in the art from the description below.

In order to address the aforementioned problems and other problems, there is provided a method for removing noise in synthetic images according to an aspect of the disclosure. The method may include generating a synthetic image based on at least a first image received from a first-exposure channel and a second image received from a second-exposure channel using an image sensor, determining a fusion ratio for the first image and the second image based on the synthetic image, generating a synthetic weight image based on the fusion ratio, and performing noise removal on the synthetic image using the synthetic weight image.

According to an aspect of the disclosure, the determining the fusion ratio may include determining whether each area among a plurality of areas of the synthetic image is of the first image from the first-exposure channel or the second image from the second-exposure channel; and based on the determining, determining a first level corresponding to a first usage ratio and a second level corresponding to a second usage ratio of the each area using a pre-defined level. Here, the first-exposure channel may be a long-exposure channel and the second-exposure channel may be a short-exposure channel.

According to an aspect of the disclosure, the synthetic weight image may be generated by representing the each area based on the first level and the second level.

According to an aspect of the disclosure, the performing noise removal on the synthetic image may determine an intensity of motion detection (MD) and spatial noise filtering (SNF) of the each area by a weighted sum of pre-determined threshold values for MD and SNF for each channel of the first-exposure channel and the second-exposure channel, based on the synthetic weight image.

According to an aspect of the disclosure, the method may further include combining and applying the pre-determined threshold values for the MD and the SNR of the each channel using a scaling curve for the synthetic weight image.

According to an aspect of the disclosure, the method may further include performing scale down on a resolution of the synthetic weight image.

According to an aspect of the disclosure, the each area may be set in pixel units or as areas of preset units.

In order to address the aforementioned problems and other problems, there is provided an apparatus for processing images to remove noise in synthetic images, according to an aspect of the disclosure. The apparatus may include a communication interface, a memory storing instructions, and a processor operably connected to the communication interface and the memory, wherein the processor is configured to execute the instructions to generate a synthetic image based on at least a first image received from a first-exposure channel and a second image received from a second-exposure channel using an image sensor, determine a fusion ratio for the first image and the second image based on the synthetic image, generate a synthetic weight image based on the fusion ratio, and perform noise removal on the synthetic image using the synthetic weight image.

Other specific details of the disclosure are included in the detailed description and drawings.

The disclosure removes noise more effectively by applying different settings, based on the fusion ratio of a long-exposure image and a short-exposure image, to each area in a synthetic image obtained by WDR or HDR technology.

The effects according to the disclosure are not limited by the examples illustrated above, and more various effects are included in this specification.

### BRIEF DESCRIPTION OF DRAWINGS

FIG. 1 is a diagram schematically illustrating a series of procedures for processing images to remove noise in synthetic images according to one or more embodiments.

FIG. 2 is a diagram schematically illustrating a series of procedures for processing images for noise removal in synthetic images according to one or more embodiments.

FIG. 3 is a schematic diagram for describing an image processing service providing system for noise removal in synthetic images according to one or more embodiments.

FIG. 4 is a block diagram showing a configuration of a management server for managing images captured and obtained by an image processing apparatus according to one or more embodiments.

FIG. 5 is a block diagram showing a configuration of an image processing apparatus for noise removal in synthetic images according to one or more embodiments.

FIG. 6 is a flowchart schematically showing an image processing method for noise removal in synthetic images according to one or more embodiments.

FIG. 7 is a diagram illustrating an example of an image obtained by an image sensor according to one or more embodiments.

FIGS. 8A and 8B are diagrams for illustrating correlation between brightness of a synthetic weight image and a usage ratio of each channel in a synthetic image generated according to one or more embodiments.

FIG. 9 is a diagram illustrating an example synthetic weight image generated based on a synthetic image according to one or more embodiments.

FIG. 10 is a diagram describing a combined weight calculated using a Scaling curve for a synthetic weight image generated from a synthetic image, according to one or more embodiments.

FIGS. 11A and 11B are diagrams for describing a noise removal effect of a synthetic image from which noise has been removed through an image processing method according to one or more embodiments.

### DETAILED DESCRIPTION

Advantages and features of the present disclosure and methods of achieving the same will become apparent with reference to the embodiments described below in detail, along with the accompanying drawings. The embodiments described herein are non-limiting example embodiments. However, the present disclosure is not limited to the embodiments disclosed below, but will be implemented in various forms, and these embodiments are provided merely to make this disclosure complete and to fully inform those skilled in the art to which the present disclosure pertains of the scope of the disclosure, the present disclosure is defined only by the scope of the claims. In drawings, similar reference numerals may be used for similar elements.

In this document, expressions such as “has,” “can have,” “comprises,” or “can comprise” refer to the presence of the corresponding feature (e.g., elements such as numbers, functions, operations, or parts) and do not exclude the presence of additional features.

In the present disclosure, the expressions “A or B”, “at least one of A or/and B”, or “one or more of A or/and B” may include all possible combinations of the items listed together. For example, “A or B”, “at least one of A and B”, or “at least one of A or B” may all refer to (1) including at least one A, (2) including at least one B, or (3) including both at least one A and at least one B.

The expressions “first”, “second”, “firstly”, or “secondly”, used in the present disclosure may describe various components, regardless of order and/or importance, and are used only to distinguish one component from another, but do not limit the components. For example, a first user device and a second user device may represent different user devices, regardless of order or importance. For example, without departing from the scope of the rights set forth in the present disclosure, a first component may be referred to as a second component, and vice versa.

When described as a component (e.g., a first component) is “(operatively or communicatively) coupled with/to” or “connected to” other component (e.g., a second component), it should be understood that said component may be directly coupled to said other component, or may be connected via another component (e.g., a third component). On the other hand, when described as a component (e.g., a first component) is “directly coupled” or “directly connected” to another component (e.g., a second component), it may be understood that no any other component (e.g., a third component) exists between said component and said other component.

The expression “configured to” used herein may be interchangeable depending on the context, for example, “suitable for,” “having the capacity to,” “designed to,” “adapted to,” “made to,” or “capable of.” The term “configured to” does not necessarily mean only “specifically designed to” in a hardware sense. Instead, in some contexts, the phrase “a device configured to” may mean that the apparatus, together with other apparatuses or components, is “capable of” an operation. For example, the phrase “processor configured to perform A, B, and C” may refer to a dedicated processor for performing those operations (e.g.: an embedded processor), or a generic-purpose processor (e.g.: CPU or application processor) that may perform those operations by running one or more software programs stored in a memory device.

The terms used in this document are merely used to describe specific embodiments and are not intended to limit the scope of other embodiments. Singular expressions may include plural expressions unless the context clearly indicates otherwise. The terms used here, including technical or scientific terms, may have the same meaning as generally understood by those skilled in the art in the technical field described in this document. Terms defined in general dictionaries among the terms used in this document may be interpreted with the same or similar meaning in the context of the relevant technology, and unless explicitly defined in this document, they are not interpreted in an ideal or overly formal sense. In some cases, even if a term is defined in this document, it cannot be interpreted as excluding the embodiments of this document.

Each feature of the various embodiments of the present disclosure may be partially or wholly combined or integrated with each other, and as those skilled in the art would easily understand, various technical interconnections and operations are possible, and each embodiment may be independently implemented with respect to each other or may be implemented together in a related manner.

To clarify the interpretation of this specification, the terms used herein will be defined as follows.

The device referred to as “management server” here may mean a physically independent server according to the present disclosure, but is not limited thereto, and may be a single virtual machine or intended to encompass a module, program, or Docker operating on a single virtual or physical machine.

On the other hand, the terms short-exposure image and long-exposure image are used herein, where when two images are taken with different exposure times, the image with the relatively shorter exposure time is referred to as a short-exposure image, and the image with the relatively longer exposure time is referred to as a long-exposure image. This term is not intended to limit the absolute exposure times of each of the two images taken.

Additionally, “Spatial Noise Reduction (SNR)” used herein refers to a filter or processing procedure for reducing noise in the spatial domain of the image. In addition, for the convenience of explanation SNR may refer to the same concept as “Spatial Noise Filtering (SNF)” and SNR and SNF should be understood as representing the same configurations and function.

Below, by referring to the attached drawings, example embodiments of this disclosure are described in detail.

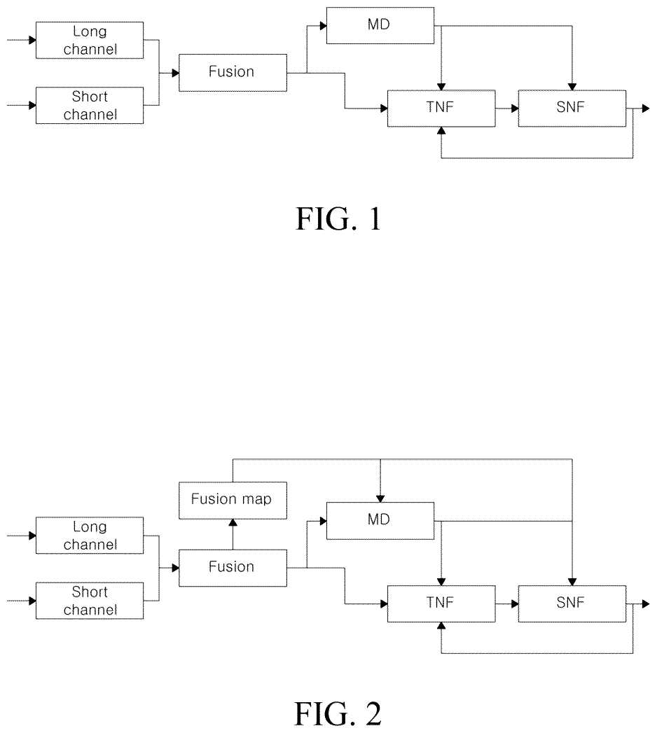

FIG. 1 is a diagram schematically illustrating a series of procedures for processing images to remove noise in synthetic images according to one or more embodiments, and such image processing procedures may be performed by an image processing apparatus according to one or more embodiments.

Referring to FIG. 1, an image processing apparatus according to one or more embodiments may obtain images from two channels, for example, a long-exposure channel and a short-exposure channel, respectively, when performing image capture using an image sensor to remove noise in a synthetic image. For example, two images are continuously captured by varying exposure settings of the image sensor. At this time, a long-exposure may be performed first, followed by a short-exposure, or vice versa, and the order is not limited.

After obtaining the images, a short-time exposed image (hereinafter, referred to as a “short-exposure image”) and a long-time exposed image (hereinafter, referred to as a “long-exposure image”) may be recorded as pairs in a frame memory. The long-exposure image and the short-exposure image may be continuously captured and recorded.

The image sensor may be configured to focus light from the outside onto a light-receiving plane of an imaging element, convert the focused light into an electric charge, and then convert that electric charge into an electrical signal. Here, the type of the image sensor is not specifically limited, and it may be a Charge Coupled Device (CCD) or a Complementary Metal Oxide Semiconductor (CMOS), for example. For example, the image sensor captures (detects) short-exposure images and long-exposure images at a pre-determined magnification (from several to several tens) of an exposure ratio.

At this time, the image sensor may perform image capture based on a capture function called Wide Dynamic Range (WDR) or High Dynamic Range (HDR). This function allows the image sensor to obtain a dynamic range wider than its native dynamic range by fusing continuously captured long-exposure images and short-exposure images.

Subsequently, motion detection is performed from the long-exposure image and the short-exposure image to generate motion information, for which, for one of the images, a gain according to the exposure ratio is multiplied and normalized, and then a difference is derived. For example, motion information may be generated based on a relationship between the detected motion from the long-exposure image and the short-exposure image and a pre-determined amount of motion.

Subsequently, based on the motion information, Temporal Noise Filtering (TNF) is applied to areas where no motion exists, and Spatial Noise Filtering (SNF) is applied to areas where motion exists.

At this time, SNF is a method that uses information from surrounding pixels of a pixel to remove noise in a current synthetic image. SNF has an advantage of avoiding blur or artifacts due to motion, since this method uses only a current frame rather than a previously processed images.

In contrast, TNF is a method that accumulates several synthetic images, and it has an advantage of actual information of an subject to be obtained as the number of accumulated synthetic images increases, noise decreases, and a level of an actual signal relatively rises. Therefore, in camera applications that prioritize information, such as surveillance cameras, TNF is necessarily applied. However, there is a disadvantage in that a sufficient number of synthetic images must be accumulated to obtain a synthetic image with noise removed, which requires time for accumulation.

However, even if a synthetic image obtained by fusion of the long-exposure image and the short-exposure image has the same gain and brightness, the noise level varies depending on whether an area in a plurality of areas in the synthetic image comes from the long-exposure image or the short-exposure image. That is, even if the brightness is the same, an area from the short-exposure image has a digital gain multiplied and synthesized, resulting in relatively more noise. In this case, applying a threshold value set for the long-exposure image does not remove the noise from the short-exposure image. Conversely, applying a threshold value set for the short-exposure image results in excessive blurring of the long-exposure image.

Following embodiments provides a system and method of more effective noise removal by generating a synthetic weight image (fusion map) using a fusion ratio of a long-exposure image and a short-exposure image for each area of a plurality of areas in the synthetic image, thereby addressing these problems.

FIG. 2 is a diagram schematically illustrating a series of procedures for processing images to remove noise in a synthetic image according to one or more embodiments of the present disclosure, and this image processing procedure may be performed by an image processing apparatus according to one or more embodiments of the present disclosure. At this time, the basic flow or each processing method of the image processing procedure shown in FIG. 2 is the same as that described earlier in FIG. 1, and redundant explanations will be omitted.

Referring to FIG. 2, the image processing apparatus according to one or more embodiments of the present disclosure differs from the image processing apparatus according to the previous embodiments in that the present embodiments generates a synthetic weight image for a synthetic image and performs motion detection and/or SNF using the generated synthetic weight image.

For example, this image processing apparatus determines whether an area of a plurality of areas which is currently being processed in a synthetic image comes from a long-exposure image or a short-exposure image. To this end, information for each area may be provided. For example, fusion ratio information of the long-exposure image and the short-exposure image for each area may be provided, and based on the fusion ratio information, a threshold value for the long-exposure image and a threshold value for the short-exposure image may be applied. In addition, a median value may be used as a set value to effectively control noise.

For example, in generating a synthetic weight image, the image processing apparatus sets an area which is captured under 100% long-exposure to the lowest level 0, and an area which is captured under 100% short-exposure to the highest level 256 in 8-bit digital imaging (or levels 16, 32, 64, 128 in 4-, 5-, 6-, 7-bit digital imaging, respectively, etc.). Next, the image processing apparatus performs noise removal in the synthetic image using that synthetic weight image.

This synthetic weight image may be used to perform motion detection (MD) in the synthetic image as shown in FIG. 2, or to perform spatial area noise reduction (SNF).

The image processing apparatus according to one or more embodiments of the present disclosure may be divided into a part that generates the synthetic weight image and a part that uses this synthetic weight image, and for this purpose, it may perform a scaling process for the synthetic weight image suitable for each module provided.

An image sensor may be provided within the image processing apparatus, but the image processing apparatus and the image sensor may also be configured separately. In the latter case, the image sensor may be provided in a separate image capturing device or user terminal, such as a smart device, to form a single system that provides image processing services together with the image processing apparatus (management server).

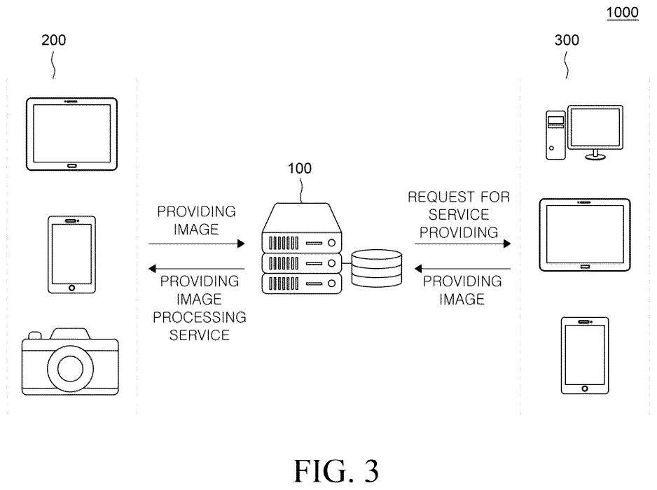

Hereinafter, a system will be described in detail based on FIGS. 3 to 5.

FIG. 3 is a schematic diagram for describing an image processing service providing system for noise removal in synthetic images according to one or more embodiments of the present disclosure.

Referring to FIG. 3, an image processing service providing system 1000 (hereinafter referred to as ‘service providing system’) for removing noise in a synthetic image according to one or more embodiments of the present disclosure may be configured to provide and manage a noise-removed synthetic image by synthesizing images captured and obtained by each channel using an image sensor and removing noise in the synthetic image based on a synthetic weight image. Accordingly, the service providing system 1000 may include a management server 100, an image processing apparatus 200, and a user terminal 300.

First, the management server 100 may correspond to or include a web server that supports the image processing apparatus 200 in processing images, and manages images captured and obtained by the image processing apparatus 200.

The management server 100 may connect to the image processing apparatus 200, one or more user terminals 300, and/or separate external devices, etc., to transmit and receive various notifications, requests, information, and data to provide an image processing service.

For example, the management server 100 receives images from the image processing apparatus 200, and stores and manages the received images in the database. In addition, at least one user may be registered corresponding to the image processing apparatus 200, and each user may be granted access rights to an image processed by the image processing apparatus 200. At this time, access rights may be granted differently for each user. At this time, the image received from the image processing apparatus 200 may be an image captured and obtained by the image processing apparatus 200 and/or an image obtained by processing the image according to an algorithm of the present disclosure.

As an embodiment, the management server 100 analyzes the image received from the image processing apparatus 200 and transmits and provides the image that satisfies pre-determined event conditions to each user terminal 300 held by at least one user.

As another embodiment, when a request for providing an image corresponding to a specific period or time is received from the user terminal 300, the management server 100 may search for a corresponding image among images stored in the database and transmit the image to the user terminal 300. At this time, the management server 100 may first determine whether the user corresponding to the user terminal 300 has access rights to the image, and only transmit the image if access rights are granted.

The image processing apparatus 200 may be at least one capturing device itself or a terminal/device equipped with at least one capturing device, and does not limit the type and number. At this time, the at least one capturing device may be equipped with an image sensor that captures images through each channel to obtain an image. Here, the at least one capturing device may include at least one of a 2D camera, a 3D camera, a ToF (Time of Flight) camera, a light field camera, a stereo camera, an event camera, an infrared camera, a lidar sensor, or an array camera. This embodiment may be applied to cameras that perform image capture based on WDR technology, such as surveillance cameras, mobile cameras, and vehicle cameras.

The image processing apparatus 200 collects images captured by each channel to generate a synthetic image, determines a fusion ratio for each area in the synthetic image, generates a synthetic weight image, and then performs noise removal in the synthetic image using this synthetic weight image.

At this time, each area in the synthetic image may be set in pixels or set in a pre-defined unit, and the unit is not limited thereto. In addition, the channel may be multiple. For convenience of explanation, the following description will be limited to a case where two channels are used, for example, a long-exposure channel and a short-exposure channel.

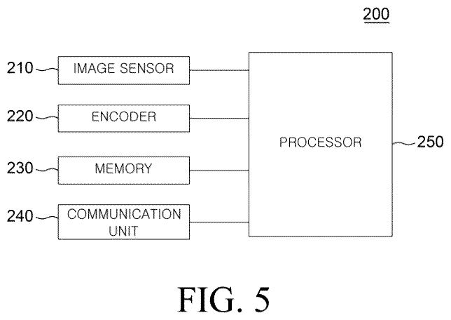

The image processing apparatus 200 will be described in detail later with reference to FIGS. 5 to 12.

The user terminal 300 refers to a terminal held by a user who is pre-registered with the management server 100 to use the image processing service, and may be one or more. At this time, each user terminal 300 may use the image processing service by executing a separate web page or platform (application) provided by the management server 100.

Each user terminal 300 may directly request and receive at least one image processed by the management server 100 and/or the image processing apparatus 200, or may receive at least one image captured and processed during a certain period of time for every providing cycle, which is pre-determined.

Thus, each user terminal 300 may display at least one received image on its display module, allowing each user to check the image visually.

Each of the user terminal 300 described above may be a computer, Ultra Mobile PC (UMPC), workstation, net-book, Personal Digital Assistants (PDAs), portable computer, web tablet, wireless phone, mobile phone, smart phone, pad, smart watch, wearable terminal, e-book reader, portable multimedia player (PMP), portable game console, navigation device, black box, digital camera, or other mobile communication terminal, etc. on which each user may install and execute a plurality of applications, without being limited thereto.

Meanwhile, the service providing system 1000 is not limited to the configuration shown in FIG. 3 and may be configured to include other devices (terminals, servers, etc.) or may be configured to exclude some configurations.

In addition, while describing the service providing system 1000, it was described that at least one image processed by the image processing apparatus 200 is provided to each user terminal 300 by the management server 100, but this is just one embodiment, and the image processing apparatus 200 may directly transmit at least one image processed to at least one pre-determined user terminal 300.

Based on this service providing system 1000, noise in the synthetic image may be removed more effectively.

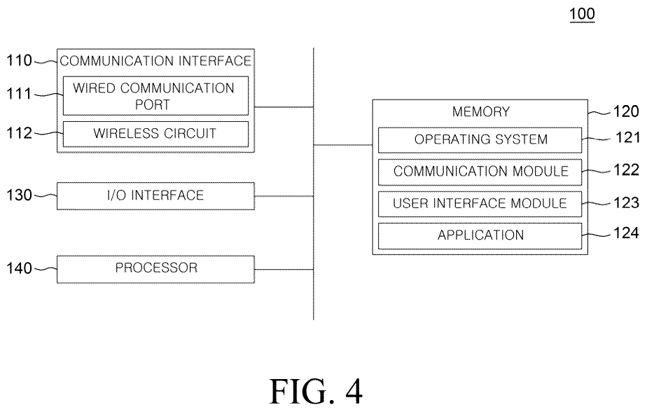

FIG. 4 is a block diagram showing a configuration of a management server for managing images captured and obtained by an image processing apparatus according to one or more embodiments of the present disclosure.

Referring to FIG. 4, the management server 100 may include a communication interface 110, memory 120, an I/O interface 130, and a processor 140, and each component may communicate with each other through one or more communication buses or signal lines.

The communication interface 110 may connect the image processing apparatus 200 and/or user terminal 300, as well as other devices, through wired/wireless communication networks to exchange data.

The communication interface 110 that enables transmission and reception of data includes a wired communication port 111 and a wireless circuit 112, wherein the wired communication port 111 may include one or more wired interfaces, for example, Ethernet, a universal serial bus (USB), a Firewire, and the like. Further, the wireless circuit 112 may transmit and receive data with external devices through RF signals or optical signals. In addition, wireless communication may use a plurality of communication standards, protocols, and technologies, such as at least one of GSM, EDGE, CDMA, TDMA, Bluetooth, Wi-Fi, VoIP, Wi-MAX, or any other suitable communication protocol.

The memory 120 may store data for at least one process (algorithm) that provides image processing services, or for a program that reproduces that process. In addition, the memory 120 may store processes for performing other operations, and this is not limited to them.

The memory 120 may store various data used in the management server 100, as well as build and store a pre-trained model as needed.

In various embodiments, the memory 120 may include a volatile or nonvolatile recording medium capable of storing various data, instructions, and information. For example, the memory 120 may include at least one type of storage medium among flash memory type, hard disk type, multimedia card micro type, card type memory (for example, SD or XD memory, etc.), RAM, SRAM, ROM, EEPROM, PROM, network storage, cloud, and blockchain database.

In various embodiments, the memory 120 may store the configuration of at least one of an operating system 121, a communication module 122, a user interface module 123, and one or more applications 124.

The operating system 121 (e.g., embedded operating systems such as LINUX, UNIX, MAC OS, WINDOWS, VxWorks, etc.) may include various software components and drivers for controlling and managing general system tasks (e.g., memory management, storage device control, power management, etc.), and may support communication between various hardware, firmware, and software components.

The communication module 122 may support communication with other devices through the communication interface 110. The communication module 122 may include various software components for processing data received by the wired communication port 111 or the wireless circuit 112 of the communication interface 110.

The user interface module 123 may receive a viewer's request or input from a keyboard, a touch screen, a microphone, etc. through the I/O interface 130, and provide a user interface on a display.

The applications 124 may include programs or modules configured to be executed by one or more processors 140.

The I/O interface 130 may connect at least one of input/output devices (not shown) of the management server 100, e.g., a display, a keyboard, a touch screen, and a microphone, to the user interface module 123. The I/O interface 130 may receive a user input (e.g., voice input, keyboard input, touch input, etc.) together with the user interface module 123 and process an instruction according to the received user input.

The processor 140 may be operatively connected to the communication interface 110, the memory 120, and the I/O interface 130 to control the overall operation of the platform server 100, and may execute various instructions through an application or a program stored in the memory 120.

The processor 140 may correspond to a computing device such as a central processing unit (CPU) or an application processor (AP). In addition, the processor 140 may be implemented in the form of an integrated chip (IC) such as a system on chip (SoC) in which various computing devices are integrated. Additionally or alternatively, the processor 140 may include a module for computing an artificial neural network model, such as a neural processing unit (NPU).

The processor 140 may be configured to receive images obtained by the image processing apparatus 200 and/or images processed according to the algorithm of this disclosure, store the received images in the memory 120 and/or a separate database, and manage those images.

The processor 140 may be configured to perform analysis based on a purpose for which the image is being received. For example, the processor 140 may be configured to detect objects in an image using an object detection algorithm. Here, the object detection algorithm may apply an artificial intelligence-based algorithm and may detect objects by applying a pre-trained artificial intelligence model.

The processor 140 may be configured to build and store at least one artificial intelligence model for analysis according to each purpose of the image. In addition to the artificial intelligence model for object detection described above, an artificial intelligence model that may obtain movement speed of a detected object may also be stored. Here, each artificial intelligence model may include an artificial intelligence model that outputs a gain value of a sensor to compensate for brightness as shutter speed corresponding to the movement speed of the object or as the shutter speed is controlled. In addition, each artificial intelligence model may be implemented through a trained artificial intelligence model that detects motion blur intensity according to the movement speed of the analyzed object through an artificial intelligence-based object recognition algorithm, and outputs the optimal shutter speed and/or sensor gain value for the shooting environment that causes the detected motion blur intensity.

In addition, the processor 140 may be configured to analyze the received image to generate metadata and index information for that metadata. At this time, the processor 140 may be configured to analyze the image information and/or sound information included in the received image together or separately to generate metadata and index information for that metadata.

FIG. 5 is a block diagram showing a configuration of an image processing apparatus for noise removal in synthetic images according to one or more embodiments of the present disclosure. However, FIG. 5 is illustrated by limiting the image processing apparatus 200 to a case where the image processing apparatus is a capturing device itself for the convenience of explanation, and at least one of the components shown in FIG. 5 may be excluded, or other components may be added. That is, the configuration shown in FIG. 5 does not limit the configuration of the image processing apparatus 200.

Referring to FIG. 5, the image processing apparatus 200 includes an image sensor 210, an encoder 220, memory 230, a communication unit 240, and a processor 250.

The image sensor 210 performs a function of capturing images of a specific area/space to obtain images, which may be implemented, for example, as a Charge Coupled Device (CCD) sensor or a Complementary Metal-Oxide-Semiconductor (CMOS) sensor, etc. Here, the image may include at least one of image data, audio data, and still images, and may further include metadata for each of the image data, audio data, and still images.

The encoder 220 performs an operation of encoding images obtained by the image sensor 210, which may follow standards such as H.264, H.265, MPEG (Moving Picture Experts Group), or M-JPEG (Motion Joint Photographic Experts Group).

The memory 230 may store at least one image obtained by the image sensor 210, that is, at least one of image data, audio data, still images, or metadata.

Here, the metadata may be data that includes at least one of object detection information based on images obtained by capturing a specific area/space (motion, sound, intrusion in designated areas, etc.), object identification information (people, vehicles, faces, hats, clothing, etc.), or detected location information (coordinates, size, etc.).

In addition, still images may be generated along with metadata and stored in memory 230, and may be created by capturing image information of a portion of the image data. For example, still images may be implemented as JPEG image files. For example, still images may be generated by cropping the region of interest within the images identified as identifiable objects among the images obtained by capturing a specific area/space for a specific period, and these may be transmitted in real-time along with metadata.

The communication unit 240 transmits image data, audio data, still images, and/or metadata to the management server 100 and/or at least one user terminal 300. The communication unit 240, according to one or more embodiments, may transmit image data, audio data, still images, and/or metadata to the management server 100 and/or at least one user terminal 300 in real-time. Meanwhile, the communication interface may perform at least one communication function among wired and wireless Local Area Network (LAN), Wi-Fi, ZigBee, Bluetooth, and Near Field Communication.

The processor 250 is connected to each of the components described above and may control the overall operation of the image processing apparatus 200, and may perform various commands through applications or programs stored in the memory 230.

A processor 250 may correspond to a computing device such as a Central Processing Unit (CPU) or an Application Processor (AP). In addition, the processor 250 may be implemented in the form of an integrated chip (IC) such as a System on Chip (SoC) that integrates various computing devices. Additionally or alternatively, the processor 250 may include a module for computing artificial neural network models, such as a Neural Processing Unit (NPU). Further, the processor 250 may be configured by or include one or more processors each including a CPU, an AP, a field programmable gate array (FPGA), and or other types of microprocessor performing the functions described herein individually or in combination.

The processor 250 may generate a synthetic image based on images received from each channel by performing image capture using the image sensor, determine a fusion ratio for long-exposure images and short-exposure images based on the synthetic image, and generates a synthetic weight image (fusion map) based on the determined fusion ratio, and then may be configured to perform noise removal on the synthetic image using the synthetic weight image.

In addition, when the processor 250 determines the fusion ratio, the processor 250 may determine whether each area of the synthetic image is a long-exposure image or a short-exposure image, and based on the determination result, the processor 250 may be configured to determine a level corresponding to a long-exposure usage ratio or a short-exposure usage ratio of each area using a pre-defined level.

Thus, the processor 250 may be configured to generate a synthetic weight image by representing each area of the synthetic image with a corresponding previously determined level.

When the processor 250 performs noise removal on the synthetic image, the processor 250 may be configured to determine intensity of Motion Detection/Estimation (MD) and Spatial Noise Reduction (SNR) of each area based on a weighted sum of pre-determined threshold values for each channel's MD and SNR based on the synthetic weight image.

In addition, the processor 250 may be configured to combine and apply preset threshold values for each MD and SNR per channel, using a Scaling curve for the synthetic weight image.

In addition, the processor 250 may be configured to perform scale down of a resolution of the synthetic weight image to reduce hardware resources.

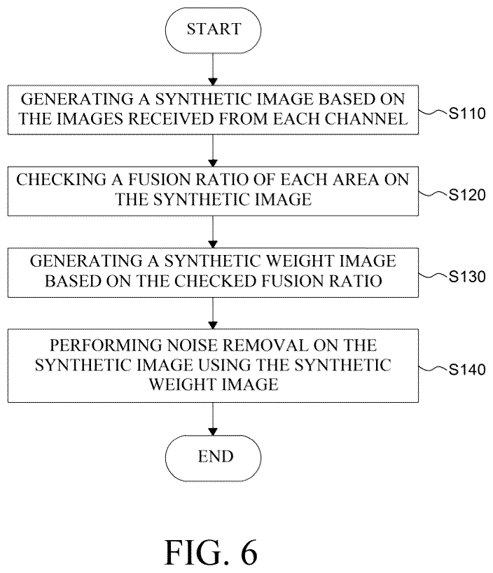

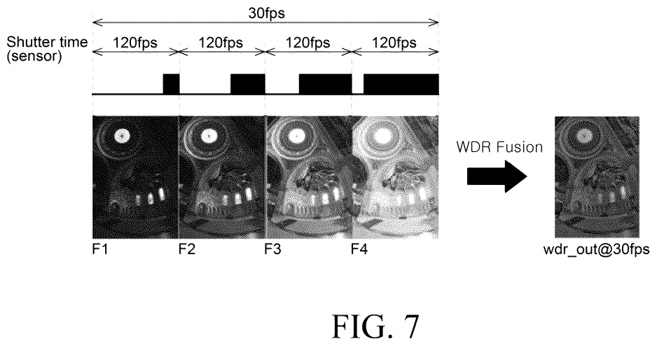

FIG. 6 is a flowchart schematically showing an image processing method for noise removal in synthetic images according to one or more embodiments of the present disclosure. Hereinafter, the image processing method will be described based on examples in FIGS. 7 to 11A and 11B while describing each step of FIG. 6.

Referring to FIG. 6, the processor 250 generates a synthetic image based on images received from each channel through an image sensor in step S110.

As shown in FIG. 7, the image sensor may obtain long-exposure and short-exposure images by adjusting a shutter time. Each shutter time may be determined by a dynamic range of a subject being of which an image is captured or the specifications of the image sensor. At this time, to obtain a long-exposure image, the shutter time is set to be long (e.g., 30 frames per second (fps)), to obtain a short-exposure image, the shutter time may be set to be short (e.g., 120 fps). The image sensor may output long-exposure and short-exposure images in a time division manner or simultaneously.

When generating a synthetic image based on WDR technology, a fusion ratio of the long-exposure channel and the short-exposure channel is represented numerically to generate a grayscale image. The scale may be used as 0~255, 0~64, etc. For example, when using the 0~255 levels, 0 indicates a pixel corresponding to 100% of the long-exposure channel, and 255 indicates a pixel corresponding to 100% of the short-exposure channel. In a case of 3-channel WDR (long, middle, short), 128 indicates that the 100% middle-exposure channel is used.

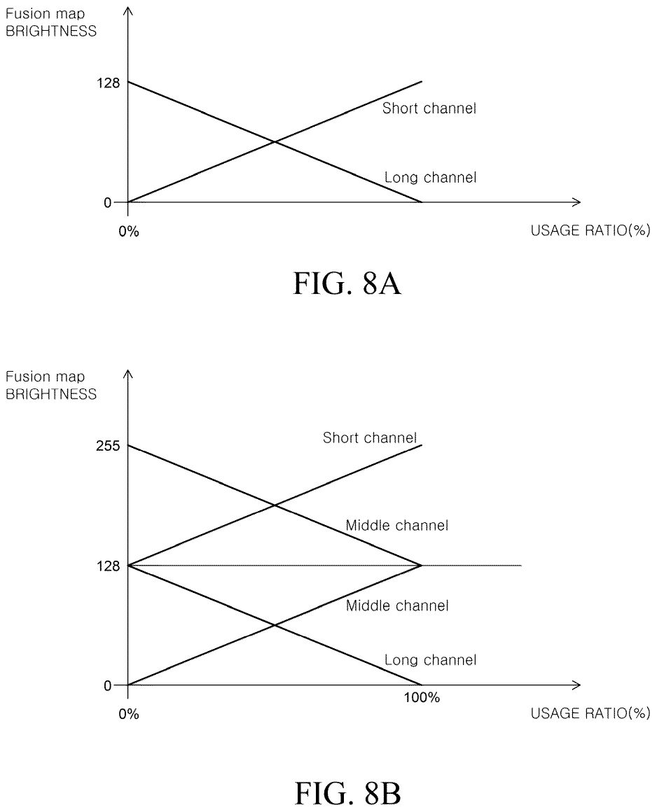

FIG. 8A shows the brightness of a synthetic weight image according to a usage ratio (i.e., fusion ratio) (%) of long-exposure and short-exposure images in a 2-channel WDR based image. FIG. 8B shows the brightness of a synthetic weight image according to a usage ratio (i.e., fusion ratio) (%) of long-exposure, middle-exposure, and short-exposure images in a 3-channel WDR based image. Generally, since there is no case where long, middle, and short are used simultaneously, values should be set according to the usage ratio of long/middle for 0~128 and middle/short for 128~255.

Next, the processor 250 determines a fusion ratio for the long-exposure image and the short-exposure image of each area based on the synthetic image generated in the S110 (S120), and generates a synthetic weight image (fusion map) based on the determined fusion ratio (S130).

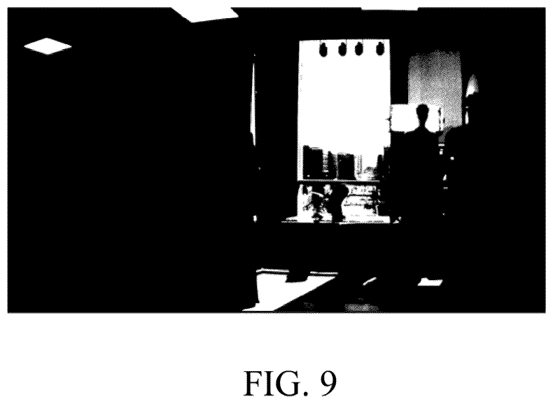

The synthetic weight image generated in the S130 is in the form shown in FIG. 9. FIG. 9 represents an example synthetic weight image generated based on the fusion ratio used to generate a WDR image using two images obtained from the long-exposure channel and the short-exposure channel.

Next, the processor 250 performs noise removal on the synthetic image using the synthetic weight image generated in the S130 (S140).

In the S140, the processor 250 combines channel-specific pre-determined threshold values for MD and SNR, according to a Scaling curve derived from the synthetic weight image, and applies the combined threshold values.

First, a case in which a pre-determined threshold value is combined and applied to each channel's MD via a Scaling curve to produce a synthetic weighted image will be described.

3DNR is a noise reduction filter that applies 2DNR using a current frame's data when there is motion in a synthetic image, and performs noise filtering in a temporal domain, which is a weighted average with a previous frame when there is no motion. As previously described, to determine whether there is motion in a synthetic image, a Sum of Absolute Difference (SAD) values of a current frame and a previous frame is generally calculated. And, by pre-determining a threshold value, if the SAD is below (or below) the threshold value, it is determined that there is no motion, and conversely, if the SAD is above (or above) the threshold value, it is determined that there is motion. At this time, the threshold value should be set to a large value under noisy conditions and to a small value under less noisy conditions. For example, in synthetic images based on WDR technology, it is difficult to set an appropriate threshold value because the level of noise varies even at the same brightness. However, using the synthetic weight image generated according to the present disclosure may address this problem.

For example, a threshold value MDTh_{L} based on a long-exposure channel and a threshold value MDTh_{S} based on a short-exposure channel may be combined, as shown in <Equation 1> below.

$${MDTh}_{WDR} = {W}_{L} \times {MDTh}_{L} + ( 1 - {W}_{L} ) \times {MDTh}_{S} \qquad < Equation 1 >$$

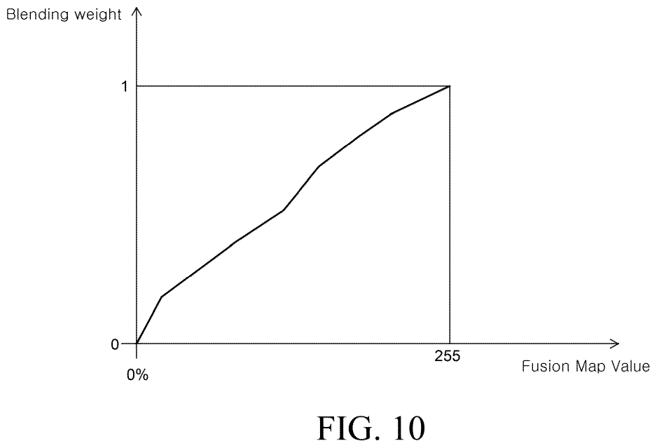

Here, W_{L} is a value calculated using the synthetic weight image, which may be set appropriately by a user using a Scaling curve as shown in FIG. 10.

In addition, how to combine pre-determined threshold values for the two channels through the Scaling curve for the synthetic weight image is described below.

Generally, noise of the an image captured by an image sensor increases as the gain of the image sensor increases. In a case of WDR, the area of the short-exposure channel is first scaled to a brightness similar to that of the long-exposure channel during the synthesis process, as a result, a digital gain is multiplied, leading to relatively high noise. Therefore, the threshold value that determines the strength of SNF should also be applied differently for the long-exposure channel and the short-exposure channel to effectively remove noise. To do this, the same method as that described for MD may be applied.

For example, a threshold value SNFTh_{L} based on the long-exposure channel and a threshold value SNFTh_{S} based on the short-exposure channel may be combined, as shown in <Equation 2> below.

$${SNFTh}_{WDR} = {W}_{L} \times {SNFTh}_{L} + ( 1 - {W}_{L} ) \times {SNFTh}_{S} \qquad < Equation 2 >$$

Thus, by setting a threshold value for SNF of the WDR technology-based synthetic image, noise in both the long-exposure channel area and the short-exposure channel area may be effectively removed. In addition, as in a case of MD, the W_{L} may be adjusted using a scaling function.

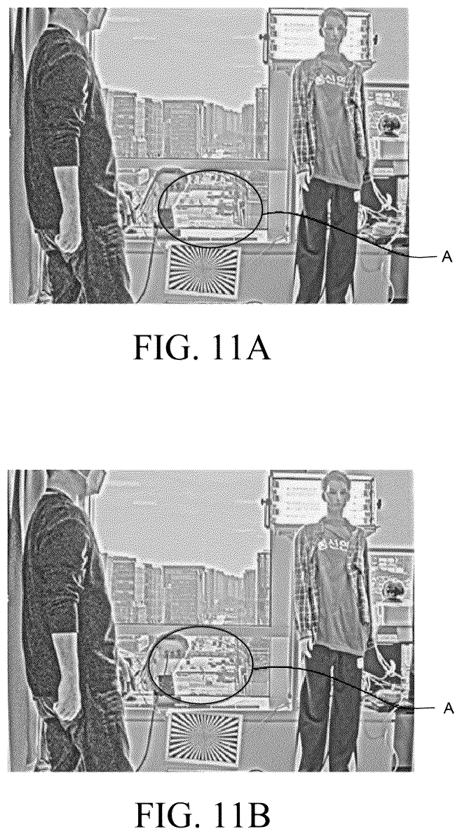

FIG. 11A shows a result of removing noise in a synthetic image without using a synthetic weight image. FIG. 11B shows a result of removing noise in a synthetic image using a synthetic weight image. FIG. 11B shows a state in which noise in a synthetic image is removed based on the image processing method according to the embodiments of the present disclosure.

Both FIG. 11A and FIG. 11B were generated to obtain the same level of noise removal effect, but in FIG. 11A using a general image processing method, it can be seen that motion ghosting occurred due to a moving vehicle outside a window A. This is because, in a case of some area outside the window A, since the long-exposure channel and the short-exposure channel were used in a combined manner, MD of the short-exposure channel was applied to the dark part of the moving vehicle where the long-exposure channel was used a lot, so a threshold value that could not be detected despite the presence of movement was applied.

On the other hand, in FIG. 11B using the image processing method according to the embodiments of the present disclosure, it can be seen that it is possible to obtain information on whether the synthetic weight image is a long-exposure image or a short-exposure image, and to use a threshold value set for MD of the short-exposure channel, by using the information, so it was determined that there was no motion ghosting to the vehicle and noise was effectively removed, even in some areas outside the window A where the movement of the vehicle exists.

Therefore, according to the present disclosure, by applying different set values based on the fusion ratio of long-exposure images or short-exposure images for each area in the synthetic image obtained by WDR technology or HDR technology, noise may be removed more effectively.

While the embodiments of the present disclosure have been described in more detail with reference to the accompanying drawings, the present disclosure is not necessarily limited to these embodiments, and various modifications may be implemented within the scope of the present disclosure. Therefore, the embodiments disclosed in the disclosure are intended to describe, not to limit, the technical idea of the disclosure, and the technical scope of the disclosure is not restricted by these embodiments. Therefore, the embodiments described above should be understood as illustrative in all respects and not limiting. The scope of protection of the present disclosure shall be construed according to the following claims below, and all technical concepts falling within the equivalent scope thereof shall be construed as being included in the scope of rights of the present disclosure.

What is claimed is:

1. A method for removing noise in synthetic images performed by an image processing apparatus, comprising:
generating a synthetic image based on at least a first image received from a first-exposure channel and a second image received from a second-exposure channel using an image sensor;
determining a fusion ratio for the first image and the second image based on the synthetic image;
generating a synthetic weight image based on the fusion ratio; and
performing noise removal on the synthetic image using the synthetic weight image.

2. The method of claim 1, wherein the determining the fusion ratio comprises:
determining whether each area among a plurality of areas of the synthetic image is of the first image from the first-exposure channel or the second image from the second-exposure channel; and
based on the determining, determining a first level corresponding to a first usage ratio and a second level corresponding to a second usage ratio of the each area using a pre-defined level.

3. The method of claim 2, wherein the first-exposure channel is a long-exposure channel and the second-exposure channel is a short-exposure channel.

4. The method of claim 2, wherein the synthetic weight image is generated by representing the each area based on the first level and the second level.

5. The method of claim 1, wherein the performing noise removal on the synthetic image comprises:
determining an intensity of motion detection (MD) and spatial noise filtering (SNF) of the each area by a weighted sum of pre-determined threshold values for MD and SNF for each channel of the first-exposure channel and the second-exposure channel, based on the synthetic weight image.

6. The method of claim 5, further comprising:
combining and applying the pre-determined threshold values for the MD and the SNR of the each channel using a scaling curve for the synthetic weight image.

7. The method of claim 1, further comprising:
performing scale down on a resolution of the synthetic weight image.

8. The method of claim 1, the determining the fusion ratio comprises:
determining whether each area among a plurality of areas of the synthetic image is of the first image from the first-exposure channel or the second image from the second-exposure channel, and
wherein the each area is set in pixel units or as an area of pre-determined units.

9. The method of claim 1, wherein the synthetic weight image is a grayscale image.

10. The method of claim 1, wherein the first-exposure channel is a long-exposure channel and the second-exposure channel is a short-exposure channel, and
wherein the fusion ratio is determined such that:
an area, among a plurality of areas in the synthetic image, which is captured using 100% long-exposure is set to the lowest grayscale value; and
an area among the plurality of areas in the synthetic image, which is captured using 100% short-exposure is set to the highest grayscale value.

11. The method of claim 1, wherein the synthetic image is generated further based on a third image received from a third-exposure channel,
wherein the first-exposure channel, the second-exposure channel, and the third-exposure channel are a long-exposure channel, a short-exposure channel, and a middle-exposure channel.

12. An image processing apparatus comprising:
a communication interface;
a memory storing instructions; and
a processor operably connected to the communication interface and the memory,
wherein the processor is configured to execute the instructions to:
generate a synthetic image based on at least a first image received from a first-exposure channel and a second image received from a second-exposure channel using an image sensor;
determine a fusion ratio for the first image and the second image based on the synthetic image;
generate a synthetic weight image based on the fusion ratio; and
perform noise removal on the synthetic image using the synthetic weight image.

13. The image processing apparatus of claim 12, wherein the processor is configured to execute the instructions further to:
determine whether each area among a plurality of areas of the synthetic image is of the first image from the first-exposure channel or the second image from the second-exposure channel; and
based on the determining, determining a first level corresponding to a first usage ratio and a second level corresponding to a second usage ratio of the each area using a pre-defined level.

14. The image processing apparatus of claim 13, wherein the first-exposure channel is a long-exposure channel and the second channel is a short-exposure channel.

15. The image processing apparatus of claim 12, wherein the processor is configured to execute the instructions to:
generate the synthetic image further based on a third image received from a third-exposure channel,
wherein the first-exposure channel, the second-exposure channel, and the third-exposure channel are a long-exposure channel, a short-exposure channel, and a middle-exposure channel.
